(19) United States
(12) Patent Application Publication
(10) Pub. No.: US 2008/0036979 A1
(43) Pub. Date: Feb. 14, 2008

(54) Motion picture display apparatus

(76) Inventor: Lincong Yang, Wneling City (CN)

Correspondence Address: SUITER SWANTZ PC LLO, 14301 FNB PARKWAY, SUITE 220, OMAHA, NE, 68154, US

(21) Appl. No.: 11/901,352

(22) Filed: Sep. 17, 2007

(30) Foreign Application Priority Data
Aug. 13, 2006 (CN) 2006201315033

(51) Int. Cl. G03B 21/20

(52) U.S. Cl. 353/86; 352/242

(57) ABSTRACT

A motion picture display apparatus according to the present invention comprises a casing, a transparent picture panel mounted on the casing, a motor mounted in the casing, a background picture disposed on rear of said dynamic picture device. The dynamic picture device is driven by the motor. Motion picture display further comprises a driving shaft, a driven shaft and a transparent film which is rotatably connected between the driving shaft and the driven shaft in an endless rotating manner. The driving shaft is connected with the motor. The dynamic picture device is driven by the motor rotated in front of the background picture. The dynamic picture comprises a plurality of designs having at least two design layers, and the contents and colors of the design layer are identically printed on the film. A light source disposed on a rear portion of the background picture illuminates the background picture.

### CROSS-REFERENCES TO RELATED APPLICATIONS

This application claims priority to Chinese Patent Application No. 2006201315033, filed on Aug. 13, 2006. Chinese Patent Application No. 2006201315033 is incorporated herein by reference.

### FIELD OF INVENTION

The present invention relates to a motion picture display apparatus, and more particularly to a motion picture display apparatus suitable for displaying an effect of multilayer pictures.

### BACKGROUND OF THE PRESENT INVENTION

In prior art, a motion picture display apparatus uses a fixed background picture and a dynamic film in order to show its effect of multilayer pictures. However the dynamic picture of these devices is generally a single layer picture, and the devices are unable to provide variety of dynamic pictures.

Consequently a motion picture display apparatus providing the effect of multilayer pictures is needed.

### SUMMARY OF THE PRESENT INVENTION

An object of the present invention is to provide a motion picture display apparatus providing the effect of multilayer pictures. A motion picture display apparatus according to the present invention comprises a casing, a transparent picture panel mounted on the casing, a motor mounted in the casing, a background picture disposed on rear of said dynamic picture device. The dynamic picture device is driven by the motor. Motion picture display further comprises a driving shaft, a driven shaft and a transparent film which is rotatably connected between the driving shaft and the driven shaft in an endless rotating manner. The driving shaft is connected with the motor. The dynamic picture device is driven by the motor rotated in front of the background picture. The dynamic picture comprises a plurality of designs having at least two design layers, and the contents and colors of the design layer are identically printed on the film. A light source disposed on a rear portion of the background picture illuminates the background picture.

The transparent film has equivalent internal and external design layers, providing the same transparent design whether viewing the image from the obverse or reverse. The motion display apparatus may reduce friction and noise and adjust difference of speed as the two rollers of the driven shaft rotate independently, therefore the film may rotate in a smooth manner and the rollers also may maintaining the proper positioning of the film. The background picture may be composed of a transparent film of transparent board with designs.

### BRIEF DESCRIPTION OF THE DRAWINGS

The numerous advantages of the present invention may be better understood by those skilled in the art by reference to the accompanying figures in which:

FIG. 1 is a front view of a motion picture display apparatus according to the present invention without a panel;

FIG. 2 is a sectional view of a motion picture display apparatus according to the present invention;

FIG. 3 is a schematic diagram of a film structure according to the present invention;

FIG. 4 is a schematic diagram of a film structure according to another embodiment of the present invention; and

FIG. 5 is a partial enlargement view of A of FIG. 1.

### DETAILED DESCRIPTION OF THE PREFERRED EMBODIMENT

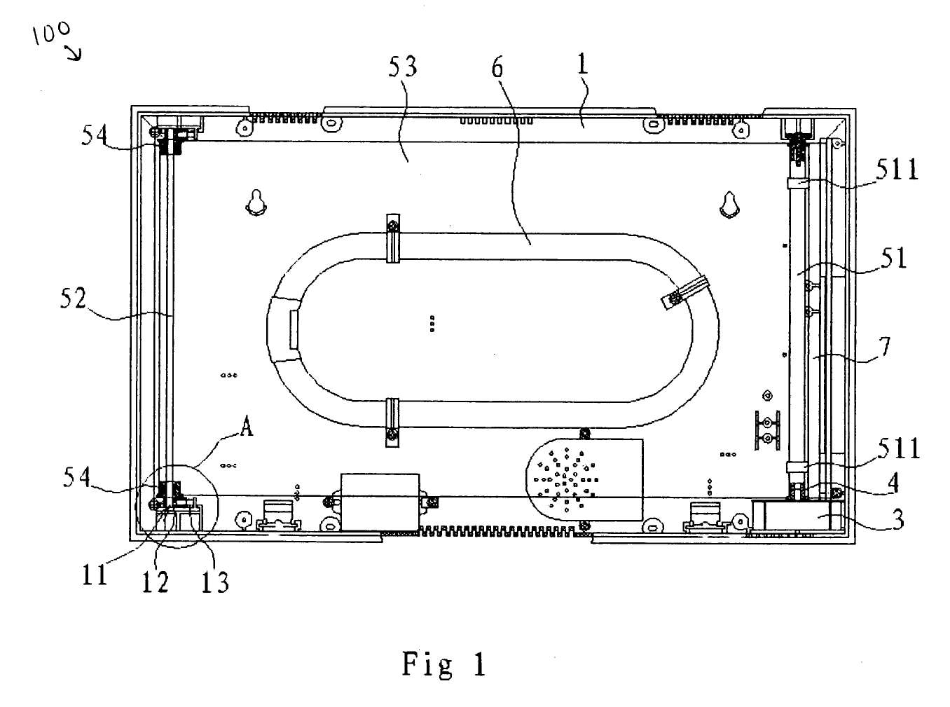

Referring to FIGS. 1 though 3, views of a motion picture display apparatus 100 according to exemplary embodiments are shown. Motion picture display apparatus 100 comprises a casing 1, a transparent picture panel 2 mounted on the casing, a motor 3 mounted in the casing 1, a dynamic picture device 5 driven by the motor 3, and a light source 6 disposed on a rear portion of a background picture 7 illuminating the background picture 7. The dynamic picture device 5 comprises a driving shaft 51, a driven shaft 52 and a transparent film 53 rotatably connected between the driving shaft 51 and the driven shaft 52 in an endlessly rotatable manner. The driving shaft 51 is connected the motor 3. An internal design layer 531 and an external design layer 532 are printed on the transparent film 53. The internal and external design layers are same and overprinted. A background picture 7 is positioned in back of the film 53. Therefore the effect of viewing the designs on the film 53 according to the present invention is equivalent regardless of who is viewing the film 53, and from either of an obverse or a reverse side. In addition, a greater dynamic effect is achieved and when the designs of the film 53 are rotated from the obverse to the reverse, because the background picture 7 is disposed in back of the film 53.

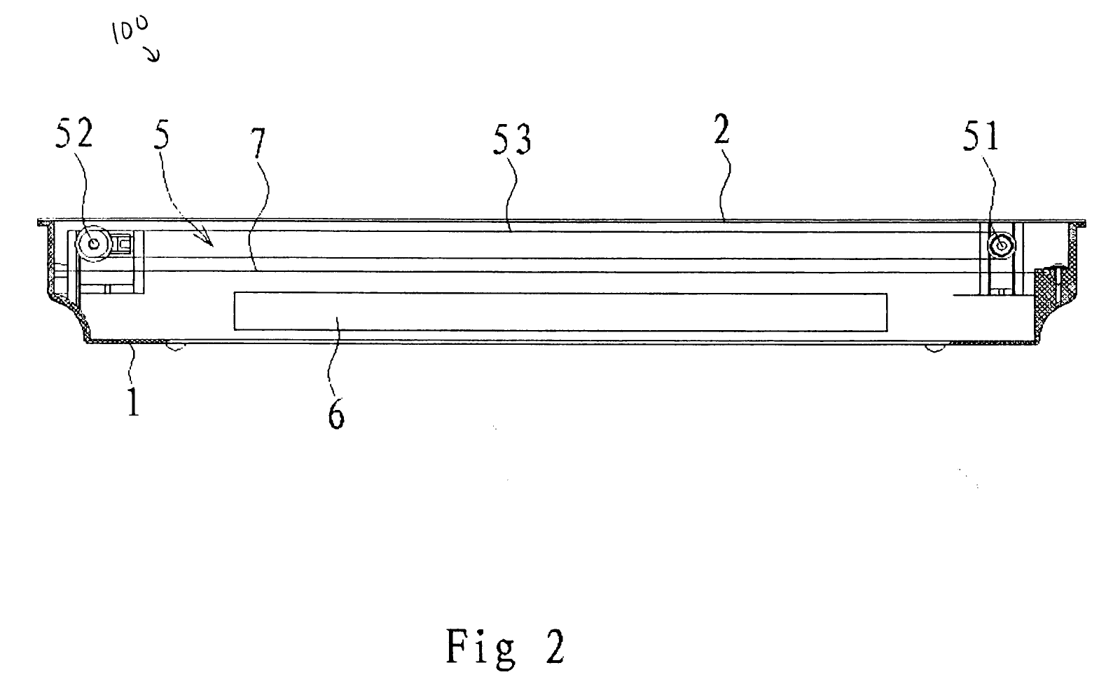

Referring to FIG. 1 and 2, the rollers 54 may be respectively installed in two ends of the driven shaft 52 can separately or synchronously rotated, and the film 53 is rotatably connected between rollers 54. Therefore the generated friction and noise may be reduced and the difference of speed of the film 53 may be compensated.

Referring to FIG. 1, the driving shaft 51 has the separation sleeves 511, the film 53 is contacted the separation sleeves. The separation sleeves 511 may enhance friction, prevent the film 53 from skidding, slipping or scratching due to shaft contact with a larger area.

Referring to FIG. 1, two ends of the background picture 7 may be mounted on the casing 1, to provide tightened fixing of the background picture 7 to the casing. The background picture may be composed of a transparent film. The background picture 7 may also be composed of transparent board material.

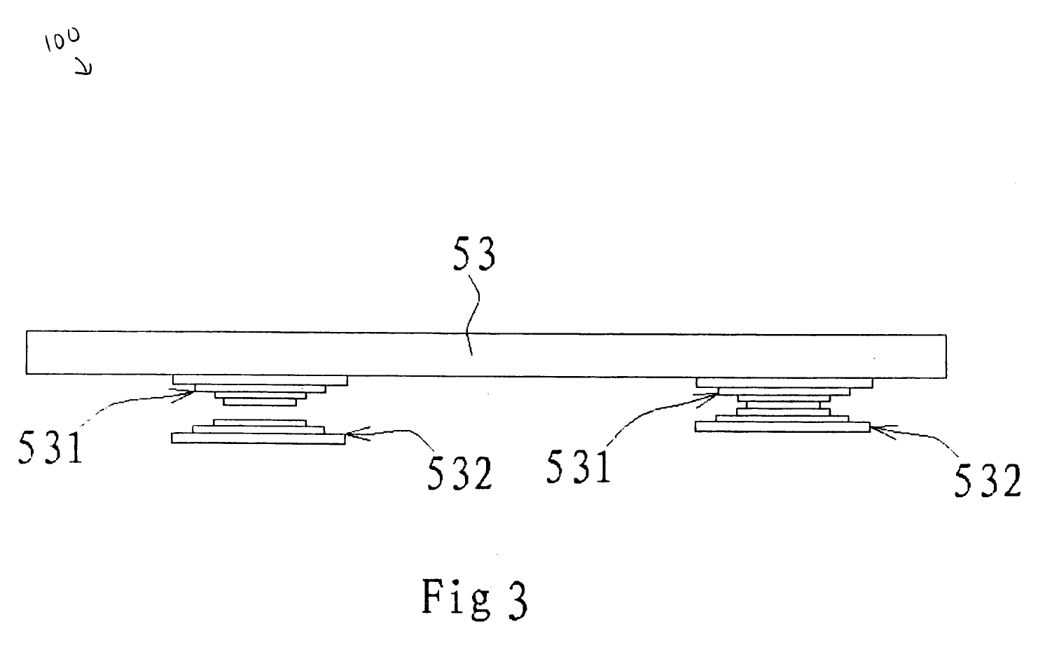

Referring FIG. 3, the external design layer 532 and the internal design layer 531 may both be comprised of multi-layer overprinted design layers. The sequence of overprinting the layers of the external design layer 532 and the internal design layer 531 may be reverse with respect to one another. For instance, the design layers may be printed in the same position, with one layer printed in a reverse order. For example, the sequence of print may be: arranging the design layers in a first order, printing the design layers in a second order that is reverse of the first order, and printing the design layers in the first order. As the design is viewed from views of both the obverse and reverse of the film 53, the image is the same. It is contemplated that the, for one side and position of the film 53, equivalent design layers are overprinted two times with a different sequence.

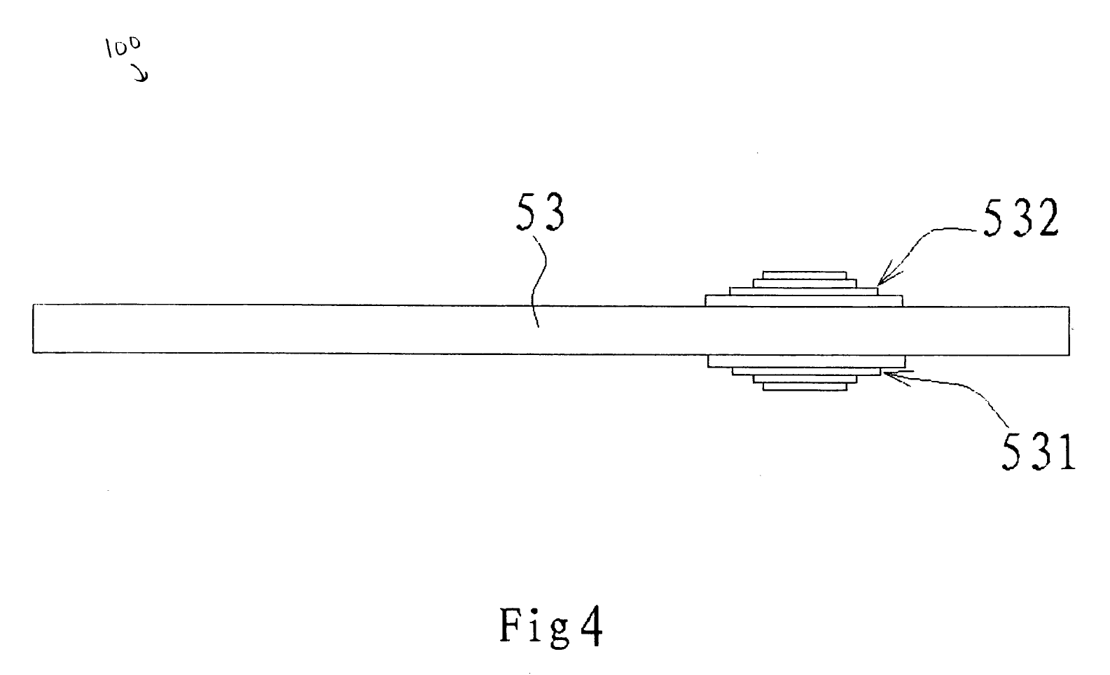

Referring to FIG. 4, in another preferred embodiment according to the present invention, the external design layer 532 is printed on the obverse of the film 53, and the internal design layer 531 is printed on the reverse of the film 53.

Referring to FIG. 1, the two ends of the driven shaft 52 are fixed on the elastic slide rods 11 of the casing 1. The driving shaft have separation sleeves suitable for contacting the film (53). The elastic slide rod 11 comprises a slide rod 12 and a spring 13 acting between the elastic slide rod 11 and the casing 1. The elastic slide rod II pushes the driven shaft 52, so as the film 53 is tightened.

Referring to FIG. 1 or 2, the light source 6 is posited at back of the background picture 7 in order to provide light for the apparatus. The light source 6 may also be positioned at a side of the casing 1 while maintaining proper illumination of the background picture 7.

The external design layer and the internal design layer both comprise multi-layer overprinted design layers, and the two multi-layer designs have the same number of layers, whereas the sequence of overprinting of the external design layer and the internal design layer are opposite, so the two sides of the design layers of the film (53) have the same content and colors.

Two ends of the driven shaft may be fixed on the plurality of elastic slide rods of the casing. The elastic slide rod comprises a slide rod and a spring acting between the elastic slide rod and the casing. The light source may be located on a rear portion of the background picture or on a lateral side of the casing.

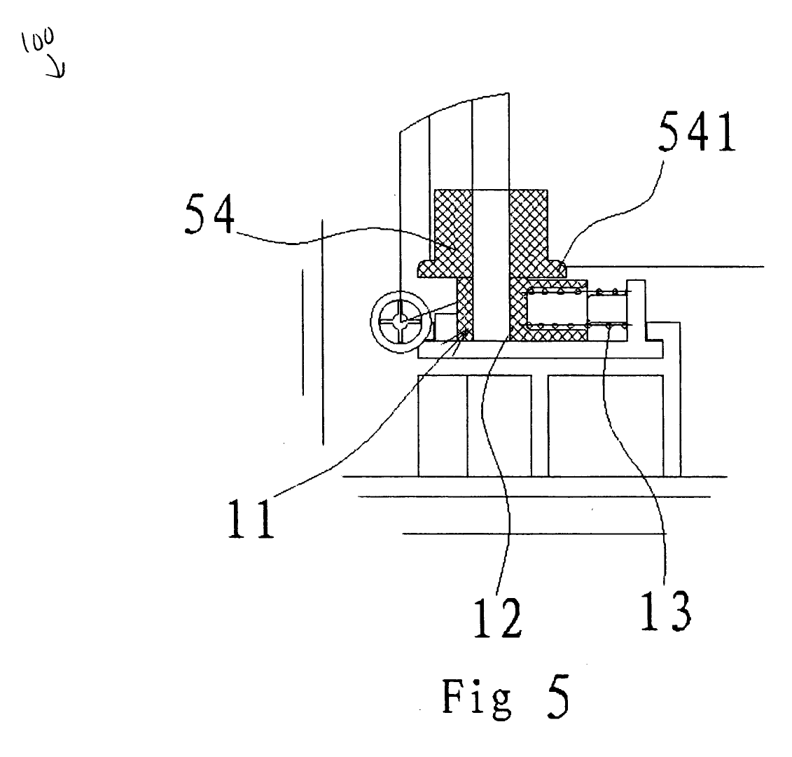

Referring to FIG. 5, the flanges 541 are formed on an external surface of the rollers acting as position limiter. Therefore the flanges 541 may prevent the film 53 from shifting out of position during rotation.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A motion picture display apparatus, comprising:
a casing;
a transparent picture panel mounted on said casing;
a motor mounted in said casing;
a background picture disposed on rear portion of said dynamic picture device;
a dynamic picture device driven by said motor;
a driving shaft;
a driven shaft; and
a transparent film is rotatably connected between said driving shaft and said driven shaft in an endlessly rotatable manner,
wherein said driving shaft is coupled to said motor, said dynamic picture device is driven by said motor rotated in front of said background picture, said dynamic picture comprises a plurality of designs having at least two design layers, the contents and colors of the design layer are identically printed on the film; and a light source disposed a rear portion of said background picture illuminates said background picture.

2. A motion picture display apparatus according to claim 1, wherein said background picture is composed of transparent film or a board comprising a design.

3. A motion picture display apparatus according to claim 1, wherein at least two rollers comprising a plurality of flanges are respectively installed at two ends of said driven shaft and are separately or synchronously rotatable.

4. A motion picture display apparatus according to claim 3, wherein said film is rotatably connected between said plurality of flanges of said rollers.

5. A motion picture display apparatus according to claim 1, wherein said driving shaft comprises separation sleeves and said film contacts said separation sleeves.

6. A motion picture display apparatus according to claim 1, wherein said background picture is fixed on said casing at least two ends or four comers.

7. A motion picture display apparatus according to claim 1, wherein the design layers of said film are manufactured by overprinting an external design layer and an internal design layer.

8. A motion picture display apparatus according to claim 6, wherein said external design layer and said internal design layer each comprise at least one multi-layer overprinted design layer, and said at least one multi-layer design comprises an equal number of layers.

9. A motion picture display apparatus according to claim 1 or 2, wherein the two ends of said driven shaft are fixed on elastic slide rods of said casing.

10. A motion picture display apparatus according to claim 9, wherein said elastic slide rod comprises a slide rod and a spring acting between said elastic slide rod and said casing.

11. A motion picture display apparatus according to claim 1, wherein said light source is located on rear of background picture or lateral side of said casing.
